(19) United States
(12) Patent Application Publication
(10) Pub. No.: US 2010/0088060 A1
(43) Pub. Date: Apr. 8, 2010

(54) APPARATUSES AND METHODS FOR MEASURING AND CONTROLLING THERMAL INSULATION

(75) Inventor: Alexander V. Padiy, Geldrop (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/531,314

(22) PCT Filed: Feb. 15, 2008
(86) PCT No.: PCT/IB2008/050564

§ 371 Date: Sep. 15, 2009

Related U.S. Application Data
(60) Provisional application No. 60/894,917, filed on Mar. 15, 2007.

(51) Int. Cl. G01N 25/18; G01K 17/00; G06F 15/00

(52) U.S. Cl. 702/136; 374/44; 374/29; 374/E17.001

(57) ABSTRACT

A mutual capacitance measurement is acquired for two thermally and electrically conductive bodies separated by an intervening dielectric material. At least one of (i) a thermal conductance and (ii) a heat transfer rate between the two thermally and electrically conductive bodies is determined based at least on the mutual capacitance measurement. For example, a thermal conductance between the two thermally and electrically conductive bodies may be determined as the mutual capacitance measurement scaled by a ratio of the thermal conductivity of the intervening dielectric material and the dielectric constant of the intervening dielectric material.

The following relates to the thermal measurement arts. It finds particular application in measuring temperature, heat flux, thermal conductance, and related thermal quantities, and is described with particular reference thereto. The following finds more general application wherever such measurements are of value, such as in measurement of core body temperature, measurement of heat flux from an infant, and so forth.

A common arrangement for thermal control is to wrap or coat a relatively high thermal conductivity body with an insulating layer, blanket, coating, or the like so as to retain heat in the high thermal conductivity body, or to control or restrain passage of heat out of (or in some cases into) the high thermal conductivity body. A ubiquitous example of such an arrangement is the living human body, which has a core body temperature maintained at about 37° C. This temperature is maintained by heat-generating metabolic processes balanced against heat loss through the skin, which serves as the blanketing insulating layer. Other examples of this general configuration include an industrial furnace that loses heat through blanketing carbon or graphite fiber insulation, or a house that loses heat through blanketing fiberglass insulation.

In engineering design, a blanket, layer, coating, or the like of an insulation material of appropriate shape and dimensions is typically chosen to fulfill a specification on the maximum allowed rate of heating or cooling under expected operating conditions. Additional measures are optionally taken to prevent excessive heating or cooling of the structure, such as the use of a fan for cooling the processor of a computer. The fan operates to increase the heat flow from the processor when a temperature sensor at or near the processor indicates the processor is too hot. In a more complex arrangement, the computational load of the processor is monitored and the fan is activated responsive to high computational load. This approach enables the fan to be activated proactively before the processor gets undesirably hot.

In a passive engineering design approach, the insulation characteristics such as material, thickness, and so forth are selected to provide desired heat flux characteristics. Once in place, the insulation is assumed to work as designed. In some cases, changes in insulation performance can be compensated by control of internal heat generation, as occurs in the case of the living human body and in a feedback controlled furnace. However, such regulation can only correct for insulation degradation up to a point. Additionally, such regulation can result in operational inefficiency, such as when a furnace draws more power or consumes more fuel in order to generate additional heat to compensate for insulation degradation.

In a related application, an insulation member sometimes forms an integral part of a thermal measurement device. In known devices, the thermal conductance of the insulator is measured or otherwise determined a priori, and serves as an input to the thermal measurement processing. In some heat flux sensor designs, for example, a temperature difference across an insulation layer is measured, and the heat flux value is then computed by multiplying the temperature difference and the a priori-known thermal conductance. If the thermal conductance differs from the a priori assumed value, then the derived heat flux measurement is in error. Such an erroneous thermal conductance can result if, for example, the thickness of the insulation layer changes due to plastic deformation over time, or the insulation layer changes composition for example by becoming wet due to humidity or other water exposure, or so forth.

For such applications, it would be useful to be able to measure the heat flux, thermal conductance, or related parameters of the insulating layer, blanket, or so forth in an efficient and rapid manner. Existing methods for making such measurement typically involve varying a geometrical characteristic, such as mechanically varying the thickness of the insulating layer, measuring a temperature difference across the insulating layer at several thicknesses, and deriving the thermal conductance as a function of thickness. As another approach, the temperature at one side of the insulating layer can be varied in a known manner, and the temperature at the other side measured to characterize the thermal conductance. These methods rely upon geometrical knowledge which may be erroneous, and employ mechanical or temperature manipulation that limits the speed and efficiency of the thermal conductance measurements.

As another approach, the thermal conductance can be estimated from first principles, taking into account the intrinsic thermal conductivity of the insulating material and the geometry. Such first principles estimation is prone to errors from diverse sources such as inaccurate geometrical measurements, or use of an inaccurate tabulated thermal conductivity value or deviation of the material composition of the actual insulation layer from that of the material for which the intrinsic thermal conductivity is tabulated.

The aforementioned approaches rely upon some a priori knowledge of the insulation, such as its thickness, composition, intrinsic thermal conductivity, or so forth. It would be useful to be able to measure heat flux, thermal conductance, or related parameters of the insulating layer, blanket or so forth in a manner that does not rely upon these considerations. Such measurements would be particularly valuable in situations where the insulation geometry may change during the measurement or between measurements, or where the geometry may be difficult to determine.

The following provides a new and improved apparatuses and methods which overcome the above-referenced problems and others.

In accordance with one aspect, a thermal measurement method is disclosed, comprising: acquiring a mutual capacitance measurement for two thermally and electrically conductive bodies separated by an intervening dielectric material; and determining at least one of (i) a thermal conductance and (ii) a heat transfer rate between the two thermally and electrically conductive bodies based at least on the mutual capacitance measurement.

In accordance with another aspect, a sensor is disclosed. A proximate conductive body or layer is in thermal communication with skin. A distal conductive body or layer is relatively further away from the skin than the proximate conductive body or layer. A dielectric material or layer is disposed between the proximate and distal conductive bodies or layers. A proximate temperature sensor is in thermal communication with the proximate conductive body or layer to acquire a temperature measurement of the proximate conductive body or layer. A distal temperature sensor is in thermal communication with the distal conductive body or layer to acquire a temperature measurement of the distal conductive body or layer. A capacitance meter is configured to acquire a mutual capacitance measurement of the proximate and distal conductive bodies or layers. A processor is configured to determine at least one of (i) a thermal conductance and (ii) a heat transfer rate between the proximate and distal conductive bodies or layers based at least on the temperature measurements of the distal and proximate conductive bodies or layers and on the mutual capacitance measurement.

In accordance with another aspect, a thermal measurement system is disclosed, comprising: a capacitance meter operatively connected with two thermally and electrically conductive bodies separated by an intervening dielectric material to acquire a mutual capacitance measurement between the two thermally and electrically conductive bodies; and a processor configured to execute an algorithm determining at least one of (i) a thermal conductance and (ii) a heat transfer rate between the two thermally and electrically conductive bodies based at least on the mutual capacitance measurement.

One advantage resides in facilitating measurement of heat flux, thermal conductance, or related parameters of a layer, blanket, coating, or so forth.

Another advantage resides in enabling determination of heat flux, thermal conductance, or related parameters of a body without relying upon a priori knowledge of the geometry or compositional uniformity of the body.

Another advantage resides in facilitating accurate measurement of temperature of an inaccessible body, for example by taking into account a temperature drop across an intervening layer or body.

Still further advantages of the present invention will be appreciated to those of ordinary skill in the art upon reading and understand the following detailed description.

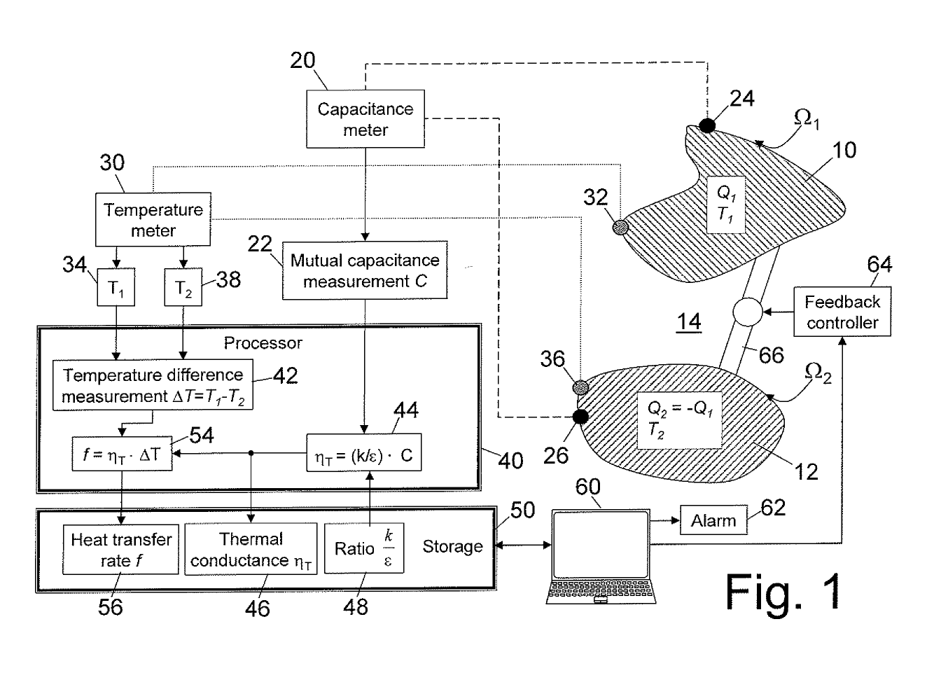

FIG. 1 diagrammatically shows a generalized system for thermal measurement of a generalized system of first and second relatively thermally conductive bodies separated by an intervening medium of relatively lower thermal conductivity.

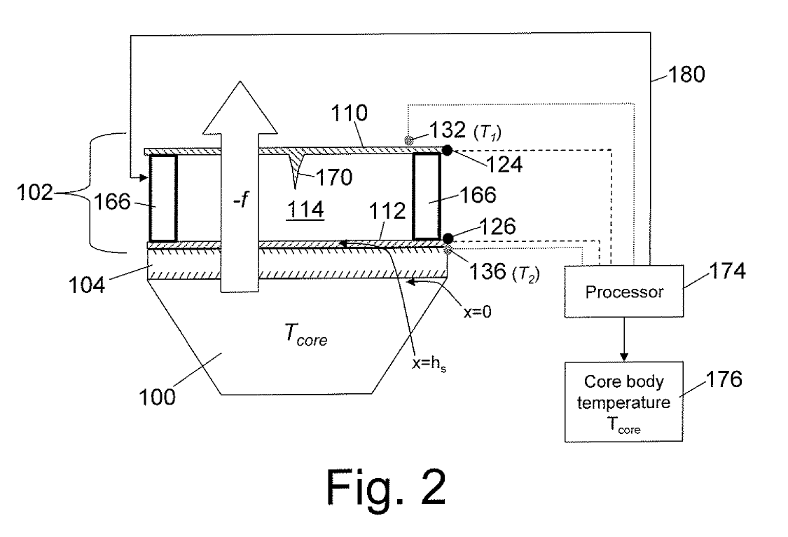

FIG. 2 diagrammatically shows a core body temperature measurement device.

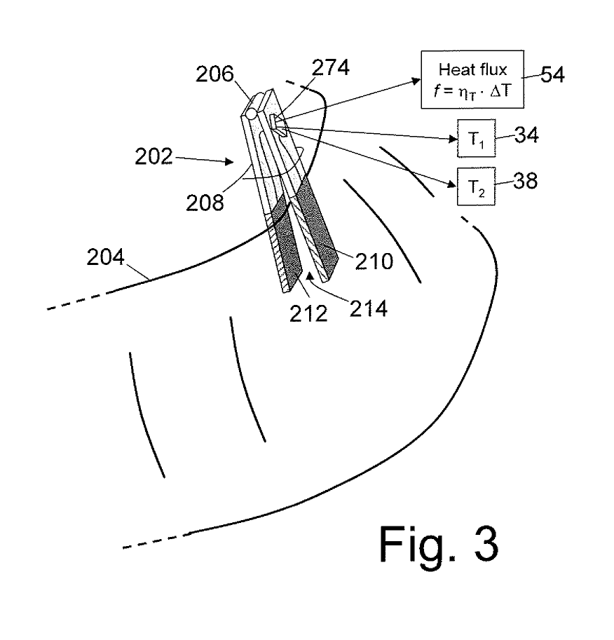

FIG. 3 diagrammatically shows a thermal measurement system conforming with the general system of FIG. 1 and embodied as a diaper clip.

With reference to FIG. 1, a generalized system includes first and second relatively thermally conductive bodies 10, 12 separated by an intervening medium 14 of relatively lower thermal conductivity. For example, the first and second relatively thermally conductive bodies 10, 12 may be metallic bodies, films, layers, or the like, while the intervening medium 14 may be a dielectric medium such as an air gap, a foam spacer, or so forth. It is desired to measure the thermal conductance of the intervening medium 14 respective to heat flow between the first and second relatively thermally conductive bodies 10, 12. Optionally, it may also be desired to measure the heat flux between the first and second relatively thermally conductive bodies 10, 12.

In the following, no assumptions are made about the geometries of the first and second relatively thermally conductive bodies 10, 12 or about the geometry of the intervening medium 14. This contrasts sharply with typical approaches used heretofore which rely upon geometrical considerations assumed to be known a priori.

In the following, the thermal conductivity and dielectric constant of the intervening medium 14 are referenced. The thermal conductivity is denoted herein as “k”, and is an intensive property of a material or substance of the intervening medium 14 denoting the ability of that medium or substance to conduct heat. The dielectric constant or permittivity of an intensive property of a material, and is denoted herein as “∈”. The relative dielectric constant of a material is also an intensive property, and is denoted herein as “∈ᵣ”. The relative dielectric constant ∈ᵣ of a material is related to the dielectric constant or permittivity ∈ of the same material according to the relationship ∈=∈ᵣ·∈ₒ where ∈ₒ≈8.8542×10⁻¹² F/m is the permittivity of vacuum. Thus, knowledge of ∈ is equivalent to knowledge of ∈ᵣ, and vice versa. The thermal conductivity k and dielectric constant or permittivity ∈ of typical materials can be obtained from handbooks or can be readily measured using standard techniques. As some illustrative examples, the relative dielectric constant of air is about 1.00, the relative dielectric constant of polyethylene is about 2.25-2.35 depending upon density and other factors, and the dielectric constant of a Kapton® MT polyimide film (available from DuPont High Performance Materials, Circleville, Ohio) has a relative dielectric constant of 4.2. Similarly, as some illustrative examples the thermal conductivity k of air is about 0.025 W/(m·K) varying somewhat depending upon humidity and other factors, the thermal conductivity of polyethylene is about 0.34-0.52 W/(m·K) again depending upon density and other factors, and the thermal conductivity of Kapton® MT polyimide film is k=0.37 W/(m·K). The first and second relatively thermally conductive bodies 10, 12 have respective body surfaces Ω₁ and Ω₂. The surfaces are assumed to be sufficiently electrically conductive such that each of the body surfaces Ω₁ and Ω₂ are equipotential surfaces. Similarly, the surfaces are assumed to be sufficiently thermally conductive such that the temperature over each of the body surfaces Ω₁ and Ω₂ is constant, but generally different for each body. It is to be appreciated that the first and second relatively thermally conductive bodies 10, 12 may deviate from these assumed properties, with some concomitant increase in measurement uncertainty.

The electrostatic potential, denoted herein as “φ”, is given by Poisson's equation:

∈·∇²φ=0 (1)

where ∇²=∇·∇ is the Laplacian operator corresponding to the divergence of the gradient of the argument function (in this case φ). For the two equipotential body surfaces Ω₁ and Ω₂, the electrostatic potential given by Poisson's equation is subject to the boundary condition:

φ|_{Ω}_{₁}=φ₁ (2),

for the first equipotential body surface Ω₁, and to the boundary condition:

φ|_{Ω}_{₂}=φ₂ (3),

for the second equipotential body surface Ω₂.

The temperature distribution, denoted herein as “T”, follows a similar “Poisson-like” relationship:

k·∇²T=0 (4),

subject to the boundary condition:

T|_{Ω}_{₁}=T₁ (5),

for the first body surface Ω₁ and to the boundary condition:

T|_{Ω}_{₂}=T₂ (6),

for the second body Ω₂.

Comparing Equations (1)-(3) and Equations (4)-(6), it is seen that analogous equations and boundary conditions apply for the electrical and thermal distributions. In the following, it is assumed that a ratio of the intensive material constants ∈ and k of the separating dielectric body is constant spatially and in time. That is, the ratio ∈/k or, equivalently, the ratio k/∈ is assumed to be spatially and temporally constant over the relevant measurement interval or intervals. This condition holds for numerous suitable dielectric materials, such as dry air or dry air-filled foam.

The assumption that ∈/k be constant in space and time does not entail any assumption that either the dielectric constant or the thermal conductivity, by itself, be constant in space or time. For example, if the intervening medium 14 is mechanically deformed in a manner which increases both the dielectric constant and the thermal conductivity, the concomitant increase in both property values may result in the ratio ∈/k remaining constant to within an acceptable level of accuracy. Moreover, when dealing with composite materials the ratio ∈/k is to be considered macroscopically, rather than respective to the constituents. For example, foam is deemed to have a spatially constant ∈/k ratio if the macroscopically observable ∈/k ratio is uniform throughout the foam material. This holds even if the constituent air pocket and matrix materials of the foam have different ∈/k ratios, such that ∈/k varies spatially within the foam when considered at a sufficiently small scale.

The thermal conductance between bodies 10, 12, denoted herein as η_{T}, is suitably defined as:

$${η}_{T} ≡ \frac{\partial f}{\partial ( Δ T )} , \qquad ( 7 )$$

where f denotes the total heat flux, that is, the heat transfer rate, flowing between body surface Ω₁ and body surface Ω₂, and ΔT denotes the temperature difference (T₁-T₂) between the body surface Ω₁ and the body surface Ω₂. Solving Equation (7) for f making use of the temperature distribution relationship of Equations (4)-(6) yields:

$$f = {∮}_{\partial {Ω}_{1}} k \cdot \frac{\partial T}{\partial n} \cdot d A = - {∮}_{\partial {Ω}_{2}} k \cdot \frac{\partial T}{\partial n} \cdot d A , \qquad ( 8 )$$

where the integrals are surface integrals of the heat flux. Substituting the total heat flux expression of Equation (8) implicating the integral over body surface Ω₁ back into Equation (7) yields:

$${η}_{T} ≡ \frac{\partial }{\partial ( Δ T )} [ {∮}_{\partial {Ω}_{1}} k \cdot \frac{\partial T}{\partial n} \cdot d A ] . \qquad ( 9 )$$

Turning now to the electrical characteristics of the generalized system, the mutual capacitance between bodies 10, 12, denoted herein as C, is suitably defined as:

$$C ≡ \frac{\partial {Q}_{1}}{\partial ( Δ ϕ )} = - \frac{\partial {Q}_{2}}{\partial ( Δ ϕ )} , \qquad ( 10 )$$

where Q₁ denotes the electrical charge on the first body 10, Q₂ denotes the electrical charge on the second body 12, the relationship Q₁=−Q₂ holding for the capacitive arrangement. The symbol Δφ=φ₁−φ₂ denotes the potential difference between the equipotential body surfaces Ω₁ and Ω₂. The charge Q₁ can be written as:

$${Q}_{1} = {\int }_{{Ω}_{1}} ρ \cdot d V = {∮}_{\partial {Ω}_{1}} ɛ \cdot ( E \cdot d A ) = {∮}_{\partial {Ω}_{1}} ɛ \cdot \frac{\partial ϕ}{\partial n} \cdot d A , \qquad ( 11 )$$

where the first integral is a volume integral over the volume enclosed by the body surface Ω₁ (that is, the volume integral over the body 10) and ρ denotes electrical charge density. The first integral results from application of Gauss' law to convert the volume integral of charge density ρ to a surface integral of electric flux. In the first integral, (E·dA) denotes a dot-product between the electric field vector E at the surface element dA and the unit normal surface vector corresponding to surface element dA. The second integral is derived from the first integral based on the relation between electric field and electric potential, namely E=−∇φ. Inserting the expression for Q₁ of Equation (11) into Equation (10) yields:

$$C ≡ \frac{\partial }{\partial ( Δ ϕ )} [ ∮ ɛ \cdot \frac{\partial ϕ}{\partial n} \cdot d A ] . \qquad ( 12 )$$

A close formal similarity is seen between the expression of Equation (9) for thermal conductance η_{T}, on the one hand, and the expression of Equation (12) for capacitance. Equations (9) and (12), combined with the electrical potential distribution of Equations (1)-(3), the analogous temperature distribution of Equations (4)-(6), and the assumption that the ratio ∈/k is constant in space and time, can be shown to yield the relationship:

$$C = ( \frac{ɛ}{k} ) \cdot {η}_{T} , \qquad ( 13 )$$

or, equivalently:

$${η}_{T} = ( \frac{k}{ɛ} ) \cdot C . \qquad ( 14 )$$

Thus, if the ratio ∈/k is known then measuring the mutual capacitance C between the bodies 10, 12 directly yields the thermal conductance η_{T} between the bodies 10, 12. Since both the dielectric constant ∈ and the thermal conductivity k are intrinsic material properties, the ratio ∈/k can be readily determined using handbook values for the constituents ∈ and k, or can be measured for a sample of the intervening material 14.

The thermal conductance η_{T} between the bodies 10, 12 is suitably expressed, for example, in units of Watts/Kelvin (W/K) or in other units of equivalent physical dimensionality. Returning to Equation (7), and recognizing that the heat transfer rate f is zero when ΔT=0, the heat transfer rate f is given by:

$$f = {η}_{T} \cdot Δ T = ( \frac{k}{ɛ} ) \cdot C \cdot Δ T , \qquad ( 15 )$$

where the last relationship is obtained using Equation (14). Thus, if the mutual capacitance C and the temperature difference ΔT are both measured, then the heat transfer rate f is readily obtained using Equation (15). The heat transfer rate f is suitably written in Watts (W), Joules/second, btu/hour, or in other units of equivalent physical dimensionality.

With continuing reference to FIG. 1, a thermal measurement system implementing the above reasoning includes a capacitance meter 20 that acquires a mutual capacitance measurement 22 of the first and second relatively thermally and electrically conductive bodies 10, 12 separated by the intervening dielectric medium 14. The capacitance meter 20 contacts the first body 10 at an electrical contact point 24 and contacts the second body 10 at an electrical contact point 26.

A temperature meter 30, such as a thermocouple readout device or other temperature readout device, reads a first temperature sensor 32, such as a thermocouple sensor or other type of temperature sensor, that indicates a temperature T₁ 34 of the first relatively high thermal conductivity body 10. The temperature meter 30 further reads a second temperature sensor 36, such as another thermocouple sensor or other type of temperature sensor, that indicates a temperature T₂ 38 of the second relatively high thermal conductivity body 12. While contact-based temperature sensors such as the illustrated thermocouples 32, 36 are typically preferred due to their high accuracy, it is also contemplated for the temperature meter 30 to employ a contact-less temperature sensor such as an optical or infrared pyrometer. Such a contact-less temperature sensor may be advantageous where one or both of the bodies 10, 12 is not tactilely accessible but is visible for optical or infrared measurements.

A processor 40 processes the temperature measurements 34, 38 in light of the mutual capacitance measurement 22 to derive thermal information. A temperature difference measurement ΔT 42 is acquired as the difference T₁-T₂ of the temperature measurements 34, 38. It is to be appreciated that in some embodiments the temperature sensors 32, 36 may be such that the temperature measurements 34, 38 are less accurate than the temperature difference measurement ΔT 42. For example, the temperature sensors 32, 36 may have a constant offset error which however is removed when the difference T₁-T₂ is computed. In other embodiments, the temperature measurements 34, 38 may be temperature-related representations such as thermocouple voltages, and the temperature difference measurement ΔT 42 is derived directly from the temperature-related representations by suitable computation without the intermediate conversion of the temperature-related representations into temperature values.

The processor 40 executes an algorithm 44 that computes the thermal conductance η_{T} 46 between the bodies 10, 12 in accordance with Equation (14). This computation makes use of the ratio k/∈ 48 for the intervening material 14, which is suitably retrieved from a storage 50 such as random access memory (RAM), read-only memory, a magnetic disk or other magnetic memory, an optical disk or other optical memory, or so forth. The ratio k/∈ 48 is suitably obtained from a handbook, vendor's datasheet for the intervening material 14, by prior measurement of the thermal conductivity k and the dielectric constant ∈, or so forth. The processor 40 also executes an algorithm 54 that computes the heat transfer rate f 56 between the bodies 10, 12 in accordance with Equation (15). Algorithm 54 optionally makes use of the thermal conductance η_{T} 46 as shown in the middle expression of Equation (15), or optionally makes use of the mutual capacitance measurement C 22 and the ratio k/∈ 48 as in the rightmost expression of Equation (15).

In some embodiments the determined heat transfer rate f 56 is computed on a per-unit area basis, thus corresponding to a heat flux f 56. This computation is typically useful when the first and second bodies 10, 12 are generally parallel planar bodies and the intervening material 14 is a layer between the parallel generally planar bodies. In such a configuration, the heat transfer rate (56) can be determined on a per-unit area basis, corresponding to a heat flux, by dividing the heat transfer rate f given by Equation (15) by the area of the planar intervening material.

In some embodiments, only one or the other of the thermal conductance 46 and the heat transfer rate 56 are determined, but not both. In embodiments in which only the thermal conductance 46 is determined, it is contemplated to omit the temperature meter 30 and temperature sensors 32, 36, since the temperature difference measurement 42 is not used in computing the thermal conductance 46.

The determined thermal conductance 46 or heat transfer rate 56 can be used in various ways. In some embodiments, a computer 60 or other device having display capability displays one or more of the thermal conductance 46, heat transfer rate 56, temperature of each body, or so forth. In some embodiments, an alarm 62 is sounded, lit, or otherwise perceptibly activated upon the thermal conductance 46 or heat transfer rate 56 going outside of an acceptable range. Such an output may be useful, for example, if the heat transfer rate 56 indicates heat emitted from a furnace, in which case an excessive heat transfer rate 56 may indicate insulation degradation or failure. In some embodiments, the determined thermal conductance 46 or heat transfer rate 56 is used as input to a feedback controller 64 that controls a mechanical actuator 66 (shown diagrammatically in the generalized system of FIG. 1) to adjust a separation of the two thermally and electrically conductive bodies 10, 12 separated by the intervening dielectric material 14.

The components of FIG. 1 are shown in a manner that facilitates exposition of the illustrative thermal measurement methods and systems. It will be appreciated that the various components may be integrated in various ways. For example, the processor 40 may include a central processing unit of the computer 60, and similarly the storage 50 may include a hard disk drive, RAM, or other storage of the computer 60. The alarm 62 is optionally a visual alarm displayed on a screen of the computer 60, an audible alarm sounded by speakers of the computer 60, or a combination thereof. The temperature meter 30 optionally includes an on-board temperature difference computation algorithm such that the temperature meter 30 directly outputs the temperature difference measurement ΔT. The storage 50 may be broken up into two or more physical storage units, such as a ROM that stores the ratio 48, a RAM that stores the thermal conductance 46 and the heat transfer rate 56, and a non-volatile memory such as a hard disk that logs the heat transfer rate measurements 56 as a function of time. The feedback controller 64 may be implemented in software executing on the computer 60. These contemplated variations are merely illustrative, and the skilled artisan can readily construct other such variations.

Having describe the generalized system with respect to FIG. 1, some illustrative examples are given with reference to FIGS. 2 and 3.

Particularly referencing FIG. 2, in one illustrative application it is desired to determine a core temperature, denoted herein as T_{core}, for a human body 100 (a portion of which is represented diagrammatically in FIG. 2). The temperature sensor 102 is placed on a skin 104 of the human subject (a portion of which is represented diagrammatically in FIG. 2). The temperature sensor includes planar thermally and electrically conductive bodies 110, 112 corresponding to the bodies 10, 12 of the generalized system of FIG. 1. The planar thermally and electrically conductive bodies 110, 112 may be, for example, films, screens, or sheets of aluminum or another metal, spaced apart by an intervening dielectric material 114 that corresponds to the intervening dielectric material 14 of the generalized system. The intervening dielectric material 114 can be air, or foam or another elastically compressible dielectric material. Heat flux −f (where the minus sign denotes that heat is flowing out of the body core 100) passes out of the skin, through body 112, through the intervening dielectric material 114, and through body 110. A thin adhesive layer (not shown) is optionally disposed between the conductive body 112 and the skin 104 to facilitate holding the sensor on the skin. Substantial temperature drops (e.g., a fraction of a degree Celsius or Kelvin, or more) are expected to occur across the skin 104 and the intervening dielectric material 114. As a result of the temperature drop across the skin, the temperature T₂ of the second thermally and electrically conductive body 112 is not expected to be the same as the core body temperature T_{body}. To correct for this, mechanical actuators 166, such as microelectromechanical (MEMS) devices, inchworm devices, piezoelectric devices, or the like, corresponding to the mechanical actuator 66 of the generalized system of FIG. 1, enables controlled adjustment or variation of the separation distance between the bodies 110, 112. As set forth in the description of the generalized system, the geometry of the separation is not critical. In the illustrated embodiment, the body 110 includes a pin or other protrusion 170 that increases sensitivity of the measuring device 102. Alternatively, one or more such pins can be included on the body 112, or on both bodies 110, 112, or such protrusions can be omitted entirely.

The illustrated measuring device 102 is used to determine the core body temperature as follows. The temperatures T₁ and T₂ of the respective bodies 110, 112 are measured using respective temperature sensors 132, 136 that are read out by a readout processor 174. In the embodiment of FIG. 2, the readout processor 174 is a general-purpose processor such as a microcomputer, microprocessor, microcontroller, or the like, that is programmed or configured to perform the functionality of the processor 40 and meters 20, 30 of the generalized system of FIG. 1. The mutual capacitance C of the bodies 110, 112 are measured across electrical contact points 124, 126 by the capacitance metering functionality of the readout processor 174.

The body core temperature T_{core} may be determined by solving a system equations according to:

$$\frac{d T}{d t} = α \frac{{d}^{2} T}{d {x}^{2}} , \qquad ( 16 )$$

where α=λ/ρcₚ, λ denotes thermal conductivity generally (as used herein, k denotes thermal conductivity specifically of the intervening medium 114), ρ denotes density, and cₚ denotes specific heat. In a suitable coordinate system, x denotes depth with x=0 corresponding to a point inside the body at temperature T_{core} and x=hₛ, corresponding to the surface of the skin. The boundary conditions for Equation (16) include the core body temperature T_{core} (to be determined) at x=0, and Tₛ at x=hₛ, that is, at the surface of the skin. Because the body 112 is highly thermally conductive, Tₛ=T₂ to a good approximation. The heat flux out of the skin is denoted qₛ herein, with the condition qₛ=−f being a suitable approximation. The heat transfer rate f and hence qₛ can be determined from the measured quantities C, T₁, and T₂ and the ratio k/∈ using Equation (15).

Assuming the skin 104 can be represented as a plane of thickness hₛ and thermal conductivity λₛ, the heat flux out of the skin qₕ (that is, heat transfer rate on a per-unit area basis) can be written as:

$${q}_{s} = - λ \frac{d T}{d x} \\ at x = {h}_{s} , \qquad ( 17 )$$

and a solution of Equation (16) can be approximated as:

$${T}_{core} = {T}_{s} + \frac{{h}_{s}}{{λ}_{s}} {q}_{s} + \frac{{h}_{s}^{2}}{2 {α}_{s}} \frac{d {T}_{s}}{d t} . \qquad ( 18 )$$

At equilibrium, Equation (18) reduces to:

$${T}_{core} = {T}_{s} + \frac{{h}_{s}}{{λ}_{s}} {q}_{s} , \qquad ( 19 )$$

which demonstrates that the core body temperature T_{core} is higher than the skin temperature by a temperature drop corresponding to (hₛ/λₛ)·qₛ. If an estimate can be provided for the ratio (hₛ/λₛ), for example using handbook values for the thermal conductivity λₛ of skin and a reasonable skin depth estimate of a few millimetres or so, then Equation (19) can be used by the processor 174 to estimate the core body temperature T_{core} 176 based on the measurements of T₁, T₂, and C.

In other embodiments, a more precise value of the core body temperature T_{core} can be estimated by having the processor 174 perform feedback control of the actuators 166, for example, by generating a feedback control signal 180 that operates the actuators 166 to set the measured heat transfer rate f determined using Equation (15) to a set point value. By varying the heat transfer rate f the values of the quantities Tₛ, qₛ, and dTs/dt can be measured for different moments in time tᵢ={t₁, . . . , tₙ} to produce a matrix of coupled equations:

$$[ \begin{matrix}1 & - {ξ}_{1} & - {η}_{1} \\ & … & \\ 1 & - {ξ}_{n} & - {η}_{n}\end{matrix} ] [ \begin{matrix}{T}_{core} \\ \frac{{h}_{s}}{{λ}_{s}} \\ \frac{{h}_{s}^{2}}{2 {α}_{s}}\end{matrix} ] = [ \begin{matrix}{T}_{s} ( {t}_{1} ) \\ ⋮ \\ {T}_{s} ( {t}_{n} )\end{matrix} ] , \qquad ( 20 )$$

in which the unknown quantities are

$${T}_{core} , \frac{{h}_{s}}{{λ}_{s}} and \frac{{h}_{s}^{2}}{2 {α}_{s}} ,$$

and where:

ξ≡qₛ(tᵢ) (21),

and

$$η ≡ \frac{d {T}_{s}}{d t} ( {t}_{i} ) . \qquad ( 22 )$$

It is assumed here that

$${T}_{core} , \frac{{h}_{s}}{{λ}_{s}} and \frac{{h}_{s}^{2}}{2 {α}_{s}}$$

are time-independent during the time interval {t₁, . . . , tₙ} over which the set of measurements are acquired. The system of Equations (20) can be solved by a least squares minimisation (LMS) procedure or other suitable coupled equations solver. This then provides the body core temperature T_{core}, and also the heat flux qₛ through the surface of the skin 104. The sampling moments tᵢ are suitably chosen such that to ensure that the system of Equations (20) is well-conditioned.

Another contemplated approach for measuring the core body temperature is as follows. The equilibrium Equation (19) can be written as:

$${T}_{s} = {T}_{core} - \frac{{h}_{s}}{{λ}_{s}} {q}_{s} \approx {T}_{core} + b \cdot f , \qquad ( 23 )$$

where the approximate relationship qₛ=−f (on a per-unit area basis) is used to derive the rightmost expression. By controllably varying the heat flux f using the feedback 180, several different data point pairs (Tₛ, f) are acquired, and the linear parameters T_{core} and b are then obtained from this dataset using conventional linear regression.

The described approaches are illustrative examples. In general, the illustrated measuring device 102 enables simultaneous measurement of the skin temperature Tₛ=T₂ and the skin heat flux qₛ=−f. From these quantities, the core body temperature T_{core} can be estimated by estimating the temperature drop across the skin based on the measured quantities Tₛ and qₛ. This temperature drop estimate can be made using various approximations or assumptions. In some embodiments, the geometry of the measuring device 102 is controllable via a feedback control 180 and actuators 166, in which case the analysis optionally utilizes data for several different configurations, e.g. different data pair (Tₛ, qₛ) values.

With reference to FIG. 3, a suitable physical arrangement of a thermal measurement device 202 conforming with the generalized system of FIG. 1 is described. The device 202 is intended as a convenient device for measuring heat transfer from an infant wearing a diaper 204. The thermal measurement device 202 is in the form of a clip, similar to a clothes-line clip, that has a biasing spring 206 and main body 208 that biases thermally and electrically conductive ends 210, 212 together to clip across a portion 214 of the diaper 204. In this arrangement, respective thermally and electrically conductive ends 210, 212 correspond to the thermally and electrically conductive bodies 10, 12 of the generalized system, while the portion 214 of diaper therebetween corresponds to the intervening medium 14 of the generalized system. The main body 208 is thermally and electrically insulating to avoid direct conductive thermal or electrical communication between the thermally and electrically conductive ends 210, 212. In some embodiments, the electrically conductive ends 210, 212 may be formed as metallic wire meshes disposed over the tips of an electrically and thermally insulating clip body.

A microprocessor or microcontroller 274 measures mutual capacitance C of the thermally and electrically conductive ends 210, 212, while temperature sensors (not shown, but suitably embodied for example by thermocouple sensors) contacting the respective ends 210, 212 are monitored by the microcontroller 274 to measure temperatures T₁, T₂ of the respective thermally and electrically conductive ends 210, 212. Thus, the microprocessor or microcontroller 274 can generate outputs including T₁, T₂, and (using Equation (15) and the mutual capacitance measurement C with suitable area scaling) the heat flux f per unit area leaving the infant's skin in the vicinity of the diaper 204. Direct measurement of the heat flux can be used, for example, to determine if the infant is adequately clothed for the present environment to avoid excessive heat loss. Such information is not as definitely provided by measurement of skin temperature alone, since the infant's internal metabolic temperature regulation has the effect of countering excessive heat loss, at least up to a point. Moreover, if suitable processing is provided as noted previously, the infant's core body temperature T_{core} can be provided as an output. These outputs can be manifested as an audible alarm (e.g., sounding when the child is taken outdoors without adequately insulating clothing), or can be transmitted wirelessly off the device 202. In a hospital or other medical care setting, the device 202 is optionally connected with a suitable output system such as the computer 60 of FIG. 1 via a wired or wireless connection.

The illustrated devices 102, 202 are examples. Because of the geometry-independent nature of the generalized system of FIG. 1, it will be appreciated that thermal measurement devices employing this configuration can have a wide range of geometric arrangements in which first and second thermally and electrically conductive bodies separated by an intervening dielectric material.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A thermal measurement method comprising:
acquiring a mutual capacitance measurement for two thermally and electrically conductive bodies separated by an intervening dielectric material; and
determining at least one of (i) a thermal conductance and (ii) a heat transfer rate between the two thermally and electrically conductive bodies based at least on the mutual capacitance measurement.

2. The thermal measurement method as set forth in claim 1, further including:
storing or displaying the determined at least one of (i) a thermal conductance and (ii) a heat transfer rate between the two thermally and electrically conductive bodies.

3. The thermal measurement method as set forth in claim 1, wherein the determining is further based on a ratio of the dielectric constant and the thermal conductivity of the intervening dielectric material.

4. The thermal measurement method as set forth in claim 1, further including:
adjusting a separation of the two thermally and electrically conductive bodies separated by the intervening dielectric material based on the determined at least one of (i) a thermal conductance and (ii) a heat transfer rate between the two thermally and electrically conductive bodies.

5. The thermal measurement method as set forth in claim 1, wherein the determining includes:
determining a thermal conductance between the two thermally and electrically conductive bodies as the mutual capacitance measurement scaled by a ratio of the thermal conductivity of the intervening dielectric material and the dielectric constant of the intervening dielectric material.

6. The thermal measurement method as set forth in claim 1, wherein the determining includes:
determining a thermal conductance η_{T} between the two thermally and electrically conductive bodies using:
$${η}_{T} = ( \frac{k}{ɛ} ) \cdot C$$
or an operatively equivalent computation, where C denotes the mutual capacitance measurement, k denotes the thermal conductivity of the intervening dielectric material, and c denotes the dielectric constant of the intervening dielectric material.

7. The thermal measurement method as set forth in claim 1, further including:
acquiring a temperature difference measurement of a temperature difference between the two thermally and electrically conductive bodies, the determining including determining (i) a thermal conductance between the two thermally and electrically conductive bodies as the mutual capacitance measurement scaled by a ratio of the thermal conductivity of the intervening dielectric material and the dielectric constant of the intervening dielectric material and (ii) a heat transfer rate between the two thermally and electrically conductive bodies based on the thermal conductance and the temperature difference measurement.

8. The thermal measurement method as set forth in claim 1, further including:
acquiring a temperature difference measurement of a temperature difference between the two thermally and electrically conductive bodies, the determining including determining a heat transfer rate between the two thermally and electrically conductive bodies based on the mutual capacitance measurement, a ratio of the dielectric constant and the thermal conductivity of the intervening dielectric material, and the temperature difference measurement.

9. The thermal measurement method as set forth in claim 1, further including:
acquiring a temperature difference measurement of a temperature difference between the two thermally and electrically conductive bodies, the determining including determining a heat transfer rate f according to:
$$f = ( \frac{k}{ɛ} ) \cdot C \cdot Δ T$$
or an operatively equivalent computation, where C denotes the mutual capacitance capacitance measurement, ΔT denotes the temperature difference measurement, k denotes the thermal conductivity of the intervening dielectric material, and ∈ denotes the dielectric constant of the intervening dielectric material.

10. The thermal measurement method as set forth in claim 1, wherein the intervening dielectric material has a generally planar shape, and the determining includes determining a heat transfer rate on a per-unit area basis corresponding to a heat flux.

11. The thermal measurement method as set forth in claim 10, wherein the determining is further based on a ratio of the dielectric constant and the thermal conductivity of the intervening dielectric material.

12. The thermal measurement method as set forth in claim 1, wherein one of the two thermally and electrically conductive bodies separated by an intervening dielectric material contacts human skin, the method further including:
estimating a core body temperature based on an acquired temperature of the thermally and electrically conductive body contacting human skin and the determined at least one of (i) a thermal conductance and (ii) a heat transfer rate.

13. The thermal measurement method as set forth in claim 1, wherein one of the two thermally and electrically conductive bodies separated by an intervening dielectric material contacts human skin, the method further including:
estimating a core body temperature based on an acquired temperature of the thermally and electrically conductive body contacting human skin and a temperature drop across the contacted skin determined based on a determined heat transfer rate.

14. A sensor comprising:
a proximate conductive body or layer in thermal communication with skin;
a distal conductive body or layer relatively further away from the skin than the proximate conductive body or layer;
a dielectric material or layer disposed between the proximate and distal conductive bodies or layers;
a proximate temperature sensor in thermal communication with the proximate conductive body or layer to acquire a temperature measurement of the proximate conductive body or layer;
a distal temperature sensor in thermal communication with the distal conductive body or layer to acquire a temperature measurement of the distal conductive body or layer;
a capacitance meter configured to acquire a mutual capacitance measurement of the proximate and distal conductive bodies or layers; and
a processor configured to determine at least one of (i) a thermal conductance and (ii) a heat transfer rate between the proximate and distal conductive bodies or layers based at least on the temperature measurements of the distal and proximate conductive bodies or layers and on the mutual capacitance measurement.

15. The sensor as set forth in claim 14, wherein the distal and proximate conductive bodies or layers comprise generally planar films, screens, or sheets.

16. The sensor as set forth in claim 15, wherein the dielectric material or layer disposed between the distal and proximate conductive generally planar films, screens, or sheets comprise air, foam, or another elastically compressible dielectric material, and the sensor further comprises:
mechanical actuators configured to perform controlled adjustment or variation of a separation distance between the distal and proximate conductive generally planar films, screens, or sheets.

17. The sensor as set forth in claim 14, wherein the distal and proximate conductive bodies or layers comprise conductive ends of a mechanically biased clip, and the dielectric material or layer comprises a portion of an item of clothing to which the clip is attached.

18. A thermal measurement system comprising:
a capacitance meter operatively connected with two thermally and electrically conductive bodies separated by an intervening dielectric material to acquire a mutual capacitance measurement between the two thermally and electrically conductive bodies; and
a processor configured to execute an algorithm determining at least one of (i) a thermal conductance and (ii) a heat transfer rate between the two thermally and electrically conductive bodies based at least on the mutual capacitance measurement.

19. The thermal measurement system as set forth in claim 18, wherein the processor is configured to execute an algorithm determining at least one of (i) a thermal conductance and (ii) a heat transfer rate between the two thermally and electrically conductive bodies based at least on the mutual capacitance measurement and a ratio of the dielectric constant and the thermal conductivity of the intervening dielectric material.

20. The thermal measurement system as set forth in claim 18, further including:
a temperature sensor configured to acquire a temperature difference measurement of a temperature difference between the two thermally and electrically conductive bodies, the processor being configured to execute an algorithm determining a heat transfer rate between the two thermally and electrically conductive bodies based at least on the mutual capacitance measurement and the temperature difference measurement.

21. The thermal measurement system as set forth in claim 18, wherein the intervening dielectric material has a generally planar shape, and the processor is configured to execute an algorithm determining a heat transfer rate between the two thermally and electrically conductive bodies on a per-unit area basis corresponding to a heat flux.

22. The thermal measurement system as set forth in claim 18, wherein one of the two thermally and electrically conductive bodies separated by an intervening dielectric material is configured to contact human skin, the system further including:
a temperature sensor configured to acquire a temperature measurement of the thermally and electrically conductive body contacting human skin, the processor being further configured to estimate a core body temperature based on the acquired temperature of the thermally and electrically conductive body contacting human skin and the determined at least one of (i) a thermal conductance and (ii) a heat transfer rate.

23. The thermal measurement system as set forth in claim 18, wherein the two thermally and electrically conductive bodies are generally planar and are separated by a generally planar intervening dielectric material.

24. The thermal measurement system as set forth in claim 18, further including:
a mechanical clip, the two thermally and electrically conductive bodies being disposed on or integral with the clip.

25. A replaceable sensor for use in the thermal management system of claim 18, the sensor comprising:
first and second conductive layers separated by a dielectric layer, the conductive layers being configured to be connected with the capacitance meter of the thermal management system and with at least one temperature sensor of the thermal management system.
